(19) United States
(12) Patent Application Publication
(10) Pub. No.: US 2004/0129118 A1
(43) Pub. Date: Jul. 8, 2004

(54) Fluid-operated torque tool

(76) Inventor: John K. Junkers, Saddle River, NJ (US)

Correspondence Address: Striker, Striker & Stenby, 103 East Neck Road, Huntington, NY, 11743, US

(21) Appl. No.: 10/335,838

(22) Filed: Jan. 2, 2003

(51) Int. Cl. B25B 23/00

(52) U.S. Cl. 81/429

(57) ABSTRACT

A fluid-operated torque tool for tightening fasteners has a fluid-operated cylinder-piston unit; a drive actuated by said fluid-operated motor unit and engageable with a fastener for tightening the latter; and an ultrasonic probe built into said drive and bringable into contact with a part of the fastener when said drive engages the fastener, for sending a sound through said part of the fastener and receiving a signal indicative of an elongation of the part of the fastener.

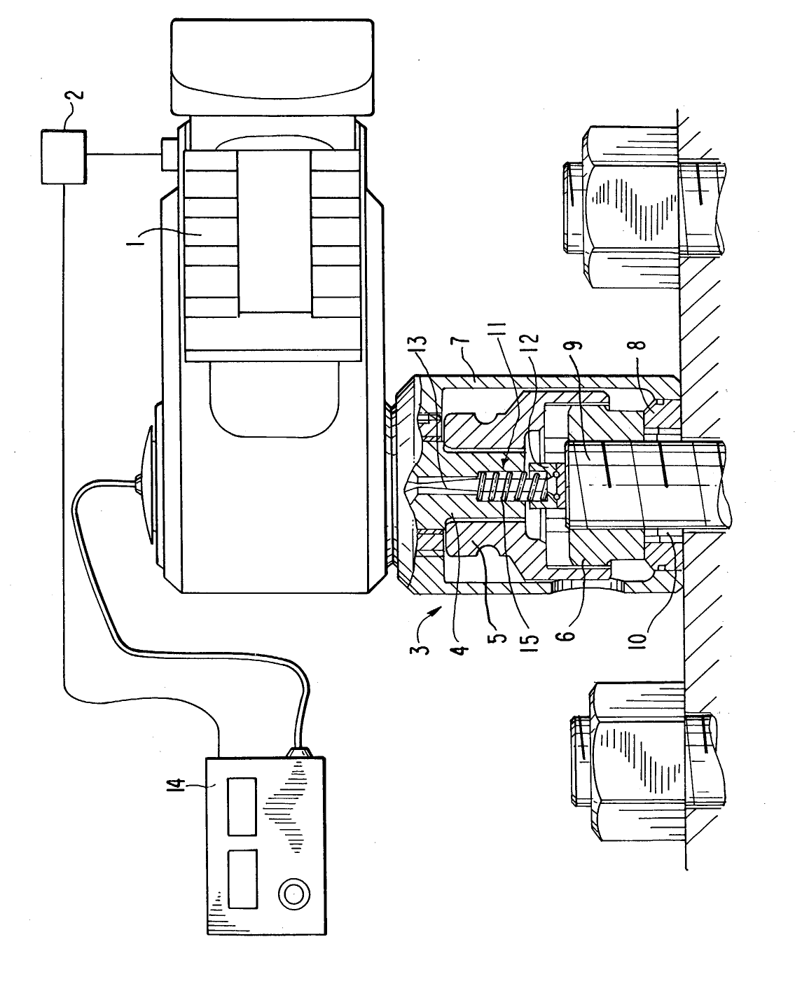

### BACKGROUND OF THE INVENTION

The present invention relates to fluid-operated torque tools for tightening threaded fasteners.

In tightening threaded fasteners, for example bolted joints it is important to create a circumferential, even clamping force. It would be ideal if every bolt would have the same identical residual load on it, that has pre-calculated and is recommended by engineering department. However, that is rather difficult because of the two unknown nut frictions, the thread and the facial friction. The torque applied to the nut has also variations that can influence the end results.

There are measuring instruments that measure the bolt elongation achieved, which in turn can be converted into bolt loads by means of calculation. Such measuring instruments include ultrasonic instruments which send a signal through the bolt and which bounces off the bottom of the bolt, at which point it measures the exact bolt length. However, such instruments are utilized independently and separately from torque tools which are used for tightening threaded fasteners. It is therefore believed to be advisable to provide a fluid-operated torque tool which is a further improvement of the existing fluid-operated torque tools for the purpose of determining the bolt elongation.

### SUMMARY OF THE INVENTION

Accordingly, it is an object of the present invention to provide a fluid-operated torque tool for tightening threaded fasteners, with which an obtained bolt elongation can be directly measured.

In keeping with these objects and with others which will become apparent hereinafter, one feature of the present invention resides, briefly stated in a fluid-operated torque tool for tightening fasteners, comprising a fluid-operated motor unit; a drive actuated by said fluid-operated cylinder-piston unit and engageable with a fastener for tightening the latter; and an ultra-sonic probe built into said drive and bringable into contact with a part of the fastener when said drive engages the fastener for sending a sound through said part of the fastener and receiving a signal indicative of an elongation of the part of the fastener.

In accordance with another important feature of the present invention it is proposed to provide a fluid-operated torque tool with ultrasonic probe deflection preventing means which include a washer arrangeable under a nut of the fastener and having an inner engaging formation connected with a bolt which forms said part of the fastener, to stop the bolt from turning with a drag friction applied by the nut to the bolt; and means for holding said washer stationary where the nut is turned.

In accordance with still a further feature of the present invention, a fluid-operated torque tool has drive element stopping means which include means for evaluating a signal received from the probe, and executing means connected with said evaluating means and operative for interrupting a fluid supply to said fluid-operated motor unit.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view schematically showing a fluid-operated torque tool in accordance with the present invention.

### DESCRIPTION OF THE PREFERRED EMBODIMENTS

A fluid-operated tool in accordance with the present invention has a fluid-operated motor, for example a fluid-operated cylinder-piston unit which is well known in the art and identified with reference numeral 1. It includes a cylinder in which fluid can be supplied from which it can be withdrawn, and a piston movable in the cylinder under the action of the fluid. The fluid can be supplied in and/or withdrawn from the cylinder-piston unit 1 through known fluid supply/withdrawal means 2.

The fluid-operated torque tool further has a drive which is identified as a whole with reference numeral 3. As shown in the drawing the drive 3 can include a drive element with a hollow drive shaft 4 connected with the piston of the fluid-operated cylinder-piston unit through for example a ratchet-pawl mechanism, and an inner socket 5 which is arranged on the hollow shaft 4 for joint rotation therewith. The inner socket 5 has an inner engaging formations, for example an inner hexagonal opening engaging with a hexagonal head of a nut 6 which forms a part of a threaded fastener to be tightened. The drive 3 further has an outer socket 7 which is immovably connected with a housing of the torque tool. The outer socket 7 has an end portion provided with an engaging formation, for example a hexagonal opening, for engaging a washer 8.

The threaded fastener to be tightened by the fluid-operated torque tool in accordance with the present invention has, in addition to the nut 6, a bolt 9 on which the nut 6 is screwed. The washer 8 is provided with an inner engaging formation, for example an inner threaded segment 10 which is threadedly connected with the bolt 9, to stop the bolt from turning with a drag friction applied by the nut 6 to the bolt 9.

In accordance with the present invention, the fluid-operated torque tool has means for measuring a bolt elongation, which is identified as a whole with reference numeral 11. The bolt elongation measuring means include an ultrasonic probe 12 which is built into the drive element. For example it is built into the hollow shaft 4 and located centrally in it. The ultrasonic probe 12 has wires 13 extending outwardly from the drive and connected to electronic processing means 14, formed for example as an electronic convertor box. A spring 14 urges the ultrasonic probe into contact with an end of the bolt 9 when the tool is applied onto the fastener, or in particular the socket 5 of driving element is engaged with the nut 6.

The bolt elongation processing means 14 can be connected with the tool, for example with the fluid supply means 2, so as to stop the torque tool from turning the nut once the desired bolt elongation has been achieved.

The fluid-operated tool in accordance with the present invention operates in the following manner.

When it is necessary to bolt a corresponding joint composed for example of two parts to be connected with one another, the fluid is supplied into the fluid-operated cylinder-piston unit 1, and the piston through the intermediate elements turns the driving element 4, 5 so as to turn the nut 6 of the threaded fastener, while the washer 8 is held stationary and prevents the bolt 9 from turning, so that the bolt does not turn but only elongates. The ultrasonic probe 11 which is brought into contact with the end of the bolt 9 sends a sound through the bolt 9, which bounces off the bottom of the bolt and the signal is supplied to the signal evaluating means so that an exact bolt length is determined and can be indicated on an indicator. An actual bolt elongation which has been achieved is compared with a desired bolt elongation which can be stored in the processing means 14, so that the fluid-operated torque tool is stopped when the desired bolt elongation has been achieved. The stopping can be provided by sending a corresponding signal to the fluid supply means 2 so as to stop the fluid supply to the cylinder-piston unit and therefore to stop turning of the driving element 4, 5 and thereby of the bolt 9.

It will be understood that each of the elements described above, or two or more together, may also find a useful application in other types of constructions differing from the types described above.

While the invention has been illustrated and described as embodied in a fluid-operated torque tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A fluid-operated torque tool for tightening threaded fasteners, comprising a fluid-operated motor unit; a drive actuatable by said operated motor unit and engageable with a fastener for tightening the latter; and an ultrasonic probe built into said drive and bringable into contact with a part of the fastener when said drive engages the fastener, for sending a sound through said part of the fastener and receiving a signal indicative of an elongation of the part of the fastener.

2. A fluid-operated torque tool as defined in claim 1, wherein said drive has a driving element formed for engaging a nut of the fastener which nut is screwed on a bolt forming said part of the fastener, said probe being built into said driving element.

3. A fluid-operated torque tool as defined in claim 2, wherein said probe is located substantially in a center of said driving element.

4. A fluid-operated torque tool as defined in claim 1; and further comprising means for biasing said probe to the part of the fastener so as to bring said ultrasonic probe into contact with said part of the fastener.

5. A fluid-operated torque tool as defined in claim 4, wherein said means for biasing include spring means operative for urging said probe into contact with said part of the fastener.

6. A fluid-operated torque tool as defined in claim 5, wherein said spring means is built into said drive.

7. A fluid-operated torque tool as defined in claim 1; and further comprising means for evaluating said signal from said probe and indicating the elongation of the fastener.

8. A fluid-operated torque tool as defined in claim 7, wherein said evaluating means include an electronic convertor box.

9. A fluid-operated torque tool as defined in claim 1; and further comprising means for preventing deflection of said probe due to turning of or torsion in the part of the fastener.

10. A fluid-operated torque tool as defined in claim 9, wherein said deflection preventing means include a washer arrangeable under a nut of the fastener and having an inner engaging formation connected with a bolt which forms said part of the fastener to stop the bolt from turning with a drag friction applied by a nut to the bolt; and means for holding said washer stationary when the nut is turned.

11. A fluid-operated torque tool as defined in claim 1; and further comprising means for stopping said drive element when the signal received from said ultrasonic probe indicates that a desired elongation has been achieved.

12. A fluid-operated torque tool as defined in claim 11, wherein said stopping means include means for evaluating the signal received from the probe, and executing means connected with said evaluating means and operative for interrupting a fluid supply to said fluid-operated motor unit.
